(19) United States
(12) Patent Application Publication
(10) Pub. No.: US 2011/0211169 A1
(43) Pub. Date: Sep. 1, 2011

(54) Projection System

(75) Inventors: Ulrich Steegmüller, Regensburg (DE); Rolf Weber, San Jose, CA (US)

(73) Assignee: OSRAM Opto Semiconductor GmbH, Regensburg (DE)

(21) Appl. No.: 12/714,698

(22) Filed: Mar. 1, 2010

(51) Int. Cl. G02B 27/48; G03B 21/28; G03B 21/14

(52) U.S. Cl. 353/38

(57) ABSTRACT

A projection system includes an opto-electromechanical component for speckle reduction, the opto-electromechanical component comprising a micro-motor having a shaft and a translucent light-diffusing element fixed to the shaft.

### FIELD OF THE INVENTION

A projection system comprising an opto-electromechanical component is described.

### BACKGROUND OF THE INVENTION

When coherent light, for instance emitted by a laser, is projected onto a surface, as for instance onto a projection screen, usually an illumination pattern can be observed which appears irregularly bright in the form of a so called “speckle pattern”. The phenomenon of a speckle pattern is a well-known effect that arises due to interference of the coherent light emitted by the laser source. In projection systems, for example a laser illuminated micro-display projection system, used for projecting images this effect can be very disturbing for an observer and therefore limits the quality of the projected images. Hence, there is a great interest in reducing the speckle effect in laser-based projection systems.

In the state of the art several attempts are known to reduce the speckle contrast.

For example the light emitted by the laser source can be coupled into an optical fiber, which can be moved and/or bent with a frequency of usually higher than 60 Hz. However, such means are not only expensive and not applicable in embedded or integrated applications, but also exhibit high optical losses due to the fiber-coupling.

Another method which may help to reduce the speckle contrast in a projected image is to provide ultra-short laser pulses instead of continuous-wave laser light, wherein the ultra-short laser pulses are produced by mode-locking a laser. The pulses typically have a pulse length of less than 10 ps, which results in an increased spectral bandwidth of the emitted laser light compared to the operation of the laser as a continuous-wave light source. However, mode-locking a laser requires a complex laser system which is not applicable for portable or embedded applications.

It is also possible to move the display screen onto which the image is projected. This can be done with a frequency of usually more than 60 Hz. However, a very special and expensive screen is required in combination with the projection system.

Furthermore, a diffusing optical component moved by a vibrating device can be placed in the beam path of the laser light. However, due to usually very small moving amplitudes those solutions require diffusers which significantly widen the laser beam. Moreover, suitable vibrating systems usually produce audible noise which can be very disturbing for an observer in the vicinity such system.

### SUMMARY OF THE INVENTION

It is an object of some embodiments of the invention to provide a projection system with an opto-electromechanical component for speckle reduction.

According to at least one aspect of the invention, a projection system comprises an opto-electromechanical component for speckle reduction. In particular, the opto-electromechanical component may have a micro-motor, to which a translucent light-diffusing element is fixed.

A light-diffusing element may here and in the following denote an optical element which at least partly alters or modifies the phase front of a coherent light beam.

According to another embodiment, the projection system comprises an opto-electromechanical component for speckle reduction, wherein the opto-electromechanical component comprises a micro-motor having a shaft, a mirror mounted on the shaft, wherein the mirror has a reflecting surface which is remote from the micro-motor and wherein a translucent light-diffusing element is mounted on the reflecting surface of the mirror.

The mirror may comprise a back surface situated opposite to the reflecting surface, wherein the back surface may be fixed to and/or mounted on the shaft of the micro-motor. During operation of the micro-motor, the mirror and the light-diffusing element mounted on the reflecting surface of the mirror are spun by the rotating shaft around the rotational axis defined by the shaft of the micro-motor.

According to another embodiment, the projection system further comprises a coherent light source emitting a coherent light beam during operation, wherein the coherent light beam is irradiated through the light-diffusing element onto the reflecting surface of the mirror and wherein the coherent light beam has an angle of greater than 0° and smaller than 90° with the reflecting surface.

Furthermore, the mirror may additionally be embodied as a beam mirror so that the coherent light beam is travelling twice through the light-diffusing element. The reflecting surface of the mirror may be arranged perpendicularly to the shaft so that the reflecting surface remains in the same plane during the rotation of the shaft. Hence, the direction of the light beam reflected by the mirror may be independent of the rotation of the mirror and the light-diffusing element during operation of the micro-motor, whereas the regions on the light-outcoupling element's surface, where the coherent light beam enters and leaves the light-outcoupling element, as well as the path through the light-outcoupling element, are continuously altered. Hence, the phase front of the reflected coherent light beam is continuously altered and/or modified during the rotation of the light-diffusing element.

According to another embodiment of the invention, a projection system comprises an opto-electromechanical component for speckle reduction, wherein the opto-electromechanical component comprises a micro-motor having a shaft and a translucent light-diffusing element mounted on the shaft. The light-diffusing element may be formed as an n-sided prism comprising an n-sided regular polygonal base face fixed to the shaft and n side faces, wherein n is a number equal to or greater than 3.

In particular, the n side faces of the light-diffusing element may be parallel to the shaft and, therefore, to the rotational axis defined by the shaft so that the base face of the light-diffusing element may be perpendicular to the shaft. The light-diffusing element may have a symmetry axis, which is the symmetry axis of the n-sided regular polygonal base face, and may be rotated by the micro-motor around this symmetry axis during operation of the micro-motor. In other words, the shaft's rotational axis may be aligned with the symmetry axis of the light-diffusing element.

According to another embodiment, the projection system further comprises a coherent light source emitting a coherent light beam during operation, wherein the coherent light beam is irradiated through the prism-shaped light-diffusing element at a right angle with respect to the shaft of the micro-motor. The coherent light beam therefore is directed perpendicularly to the rotational axis around which the light-diffusing element is spun by the micro-motor so that the angle between the faces of the prism-shaped light-diffusing element and the coherent light beam as well as the path length of the coherent beam through the light-diffusing element are continuously altered during operation of the micro-motor. Hence, the phase front of the transmitted coherent light beam is continuously altered and/or modified during the rotation of the light-diffusing element.

The continuous modifications of the coherent light beam's phase front in the above-described embodiments result in continuously altered speckle patterns on a screen which may be averaged by an observer's eye. Hence, the perception of speckle patterns can be reduced or even prevented.

According to another embodiment, the micro-motor preferably is an electrical micro-motor with dimensions of less than 1 cm and particularly preferably of less than 5 mm. The micro-motor can further be a piezo driven motor or an electric stepper motor. In particular, the micro-motor may be a DC (direct current) electrical motor. Such micro-motor can be especially applicable in embedded and/or portable applications which usually have one or more batteries as current source and which require low-power and small-size solutions. The micro-motor may provide a high rotation frequency of the shaft so that the translucent light-diffusing element is rotated at a high frequency, which means, in particular, at a frequency of more than 60 Hz, so that the speckle patterns may effectively be averaged by the human eye and the perceived speckle contrast on a screen can be significantly reduced.

According to another embodiment, a light-diffusing element may comprise at least one translucent diffractive optical element and/or at least one holographic optical element. As a micro-motor according to the embodiment described above can be used, which can be operated at high rotational frequencies, advantageously the translucent diffractive optical element may be a low-angle diffractive optical element and/or the holographic optical element may be a holographic optical element with low diffusion angle. “Low-angle” or “low diffusion angle” may denote a diffusion angle of the translucent light-diffusing element of more than 1° and less than 5°, preferably of less than 2°, so that the translucent light-diffusing element provides only a small widening of the coherent light beam.

The projection systems described here and in the following allow a compact design and arrangement of a moving light-diffusing element, which fits in hand held devices, with low power consumption and low noise level.

### BRIEF DESCRIPTION OF THE DRAWINGS

FIG. 1 shows a schematic view of a projection system with an opto-electromechanical component according to an embodiment of the invention.

FIGS. 2A and 2B show schematic views of a projection system with an opto-electromechanical component according to a further embodiment of the invention.

### DETAILED DESCRIPTION OF THE DRAWINGS

Components that are identical, of identical type and/or act identically are provided with identical reference symbols in the figures.

The projection systems according the embodiments shown in the Figures may additionally or alternatively comprise features or combinations of features as described above.

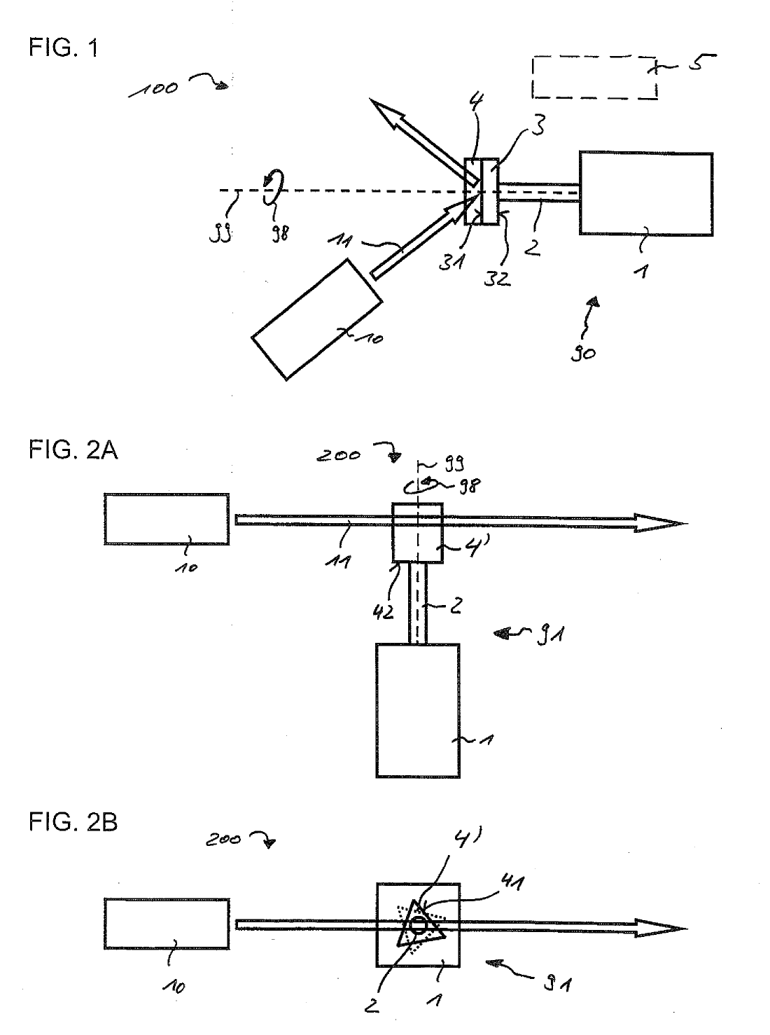

FIG. 1 shows a projection system 100 according to an embodiment of the invention, wherein the projection system 100 comprises an opto-electromechanical component 90 for speckle reduction.

The opto-electromechanical component 90 comprises a micro-motor 1 having a shaft 2, to which a mirror 3 and a translucent light-diffusion element 4 are fixed.

The micro-motor 1 of the particular embodiment is a piezo driven or electric motor, for instance a DC electric motor or DC electric stepper motor, with dimensions of less than 5 mm. The micro-motor has a low power consumption in the range of about 50 to 100 mW and is therefore in particular suitable for portable and/or embedded applications. The micro-motor 1 provides a rotation frequency of more than 60 Hz.

The mirror 3 comprises a light reflecting surface 31 and a back surface 32 situated opposite to the reflecting surface 31. The back surface 32 is fixed to the shaft 2 of the micro-motor 1 by means of a suitable mechanical or adhesive connection. The mirror 3 has a flat reflecting surface 31, which is arranged symmetrically and perpendicularly to the shaft 2 of the micro-motor 1, which allows on the one hand for a smooth and balanced rotation of the mirror 3. On the other hand, the orientation of the mirror 3 and, in particular, of the reflecting surface 31, is independent from the rotational movement induced by the micro-motor 1.

As indicated by the dashed lines, the opto-electromechanical component 90 may further comprise a magnetic component 5 which may be placed in the vicinity or close to the micro-motor 1 and/or the shaft 2, which may be for example a permanent magnet and which can be used in order to reduce the shaft play during operation of the micro-motor 1. Advantageously, the shaft 2 may then be made from a magnetic or magnetizable material such as for example a metal.

The translucent light-diffusing element 4 is fixed to the reflecting surface 31 of the mirror 3 so that during operation of the micro-motor 1, the mirror 3 and the light-diffusing element 4 are spun by the rotating shaft 2 around the rotational axis 99 of the shaft 2, as indicated by arrow 98.

The translucent light-diffusing element 4 of the shown embodiment is a translucent low-angle diffractive optical element having a diffractive pattern or a holographic optical element having a holographic pattern. The translucent light-diffusing element 4 comprises a diffractive and/or a holographic pattern with diffractive and/or holographic structures which have no rotational symmetry or, preferably, are randomly distributed and which are suitable to modify the phase front of a coherent light beam.

The diffractive pattern of the diffractive optical element or the holographic pattern of the holographic optical element is designed to provide a low diffusion angle of less than 5° and more than 1°. Such small diffusion angle is sufficient to provide enough mixing and modification of the transmitted coherent light beam 11.

Additionally, the light-diffusing element 4 can comprise a beam-shaping element or can be designed to perform also beam-shaping, for example to form a Gaussian beam to a so called hat illuminating beam applicable for micro-displays. Such optical elements are known as LCOS (“liquid crystal on silicon”) elements or DLP (“digital light processing”) elements.

The projection system 100 further comprises a coherent light source 10 emitting a coherent light beam 11 during operation, wherein the coherent light beam, while traversing the light-diffusing element 4, is irradiated onto the reflecting surface 31 of the mirror 3 and wherein the coherent light beam has an angle of greater than 0° and smaller than 90° with the reflecting surface.

The coherent light source of the shown embodiment comprises at least one laser diode, which produces a coherent light beam 11 of high beam quality with a small beam diameter. The coherent light beam 11 comprises light of at least one visible wavelength. In order to provide a multicolor beam as for example an RGB-beam, the coherent light source 10 can comprise for instance three laser diodes whose light beams are superposed and form the coherent light beam 11 comprising three coherent light beams of different colors.

The mirror 3 of the shown embodiment is a beam mirror so that the coherent light beam 11 is travelling twice through the light-diffusing element 4. As already mentioned above, the reflecting surface 31 of the mirror is arranged at a right angle with respect to the shaft 2 so that the reflecting surface 31 remains in the same plane during the rotation of the shaft 2. Hence, the direction of the light beam 11 reflected by the mirror is independent of the rotation of the mirror 3 and the light-diffusing element during 4 during operation of the micro-motor 1. However, the regions on the surface of the light-outcoupling element, where the coherent light beam 11 enters and leaves the light-outcoupling element 4, respectively, as well as the beam path through the light-outcoupling element 4, continuously change due to the rotational movement. Due to the non-symmetrical or, preferably, randomly distributed refractive and/or holographic structures of the light-diffusing element 4 the phase front of the reflected coherent light beam 11 is continuously modified during the rotation of the light-diffusing element 4, resulting in continuously altered speckle patterns on a screen which may be averaged by an observer's eye. As the light-diffusing element 4 is rotated at a frequency of more than 60 Hz, the perception of speckle patterns can be significantly reduced or even prevented. At the same time, the opto-electromechanical component 90 can be used as beam mirror in the projection system 100.

FIGS. 2A and 2B show a side view (FIG. 2A) and a top view (FIG. 2B) of a projection system 200 with an opto-electromechanical component 91 according to another embodiment. The following description relates to both FIGS. 2A and 2B.

The opto-electromechanical component 91 comprises a micro-motor 1 having a shaft 2, wherein a translucent light-diffusing element 4′ is mounted on the shaft 2.

The micro-motor 1 is embodied as described in connection with the embodiment shown in FIG. 1. Furthermore, the projection system may additionally comprise a magnetic component 5 (not shown) next to the micro-motor 1 and/or the shaft 2 as described in connection with the embodiment of FIG. 1.

The projection system 200 further comprises a coherent light source 10 as described in connection with the foregoing embodiment shown in FIG. 1. In particular, the coherent light beam 11 emitted by the coherent light source 10 comprises in the shown embodiment a superposition of three coherent light beams with colors red, green and blue, respectively, for an RGB projection system.

The translucent light-diffusing element 4′ is formed as an n-sided prism having an n-sided regular polygonal base face 42 fixed to the shaft 2 and n side faces 41. In the shown embodiment, n is equal to 3 so that the light-diffusing element 4′ is a three-sided regular prism. Alternatively, the light-diffusing element 4′ may comprise more than three sides, i.e. the number n may be greater than 3.

The light-diffusing element 4′ is mounted on the shaft 2 of the micro-motor 1 so that the side faces of the prism-shaped light-diffusing element 4′ are parallel to the shaft 2.

The light-diffusing element 4′ can be made from a single, prism-shaped peace of can comprise in general a number n, which is 3 in the particular embodiment shown in FIGS. 2A and 2B, of light-diffusing sub-elements which are fixed to each other, forming the prism-shaped light-diffusing element 4′.

The translucent light-diffusing element 4′ is a translucent low-angle diffractive optical element and/or a holographic optical element having a diffractive and/or holographic pattern with diffractive and/or holographic structures which, preferably, are randomly distributed and which are suitable to modify the phase front of a coherent light beam 11.

In particular, the diffractive pattern of the diffractive optical element or the holographic pattern of the holographic optical element is designed to provide a low diffusion angle of less than 5° and more than 1° so that the coherent light beam is not significantly widened while traversing the light-diffusing element 4′.

The translucent light-diffusing element 4′ can have additional properties and features as described in connection with the light-diffusing element 4 of projection system 100 shown in FIG. 1. For example, the light-diffusing element 4′ may additionally comprise or may additionally be realized as a beam shaping element as described above.

During operation of the micro-motor 1 the light-diffusing element 4′ is continuously rotated around its rotational axis 99, as indicated by arrow 98, wherein the rotational axis 99 corresponds to the symmetry axis of the base face 42. The rotational axis 99 is oriented perpendicular to the beam direction of the coherent light beam 11 so that the regions on the side faces 41 of the light-diffusing element 4′, where the coherent light beam 11 enters and leaves the light-diffusing element 4′, respectively, as well as the beam path and the beam path length through the light-diffusing element 4′ are continuously varied. Therefore, the phase front of the coherent light beam 4′ is continuously modified, which results, as already described in connection with FIG. 1, to a perpetual variation of the speckle pattern on a screen, which will be averaged by an observer's eye and therefore lead to a significant reduction or even vanishing perception of the speckle patterns.

The projection systems according to the embodiments shown in FIGS. 1, 2A and 2B have opto-electromechanical components which can be as small as 5×5×7 mm³ with a power consumption of about 50 to 100 mW. As becomes immediately apparent form the description above, the opto-electromechanical components are easy to operate by simply being switched on and off. Due to the very small size and the micro-motor, the noise level produced by the opto-electromechanical components was found to be very low and to be audible only from one inch away or closer. As already described above, the projection systems 100 and 200 further allow for using a translucent light-diffusing element with a diffusing angle of less than 1°.

The projection systems according to the embodiments shown in the Figures may additionally comprise further optical, electrical and/or electronic components and elements. Example for additional components and elements may be a power source for the micro-motor and/or the coherent light source as for example a battery, optical elements for beam shaping, light modification or beam movement as for example lenses, polarizer and/or fixed or movable mirrors. Furthermore, the projection systems may be situated in a suitable housing or may even be part of a portable electronic device as for example a mobile telephone, organizer or PDA.

The invention is not restricted by the description on the basis of the exemplary embodiments. Rather, the invention encompasses any new feature and also any combination of features, which in particular comprises any combination of features in the patent claims, even if this feature or this combination itself is not explicitly specified in the patent claims or exemplary embodiments.

1. A projection system with an opto-electromechanical component for speckle reduction, the opto-electromechanical component comprising:
a micro-motor having a shaft;
a mirror mounted on the shaft, wherein the mirror has a reflecting surface which is remote from the micro-motor; and
a translucent light-diffusing element mounted on the reflecting surface of the mirror.

2. The projection system according to claim 1, wherein the reflecting surface of the mirror is perpendicular to the shaft.

3. The projection system according to claim 1, wherein the light-diffusing element comprises a translucent low-angle diffractive optical element and/or a holographic optical element with low diffusion angle.

4. The projection system according to claim 1, wherein the light-diffusing element comprises a beam-shaping element.

5. The projection system according to claim 1, wherein the opto-electromechanical component further comprises a magnetic component positioned next to the micro-motor.

6. The projection system according to the claim 5, wherein the micro-motor is a piezo motor or an electric motor.

7. The projection system according to claim 1, further comprising a coherent light source emitting a coherent light beam during operation, wherein the coherent light beam is irradiated onto the reflecting surface having an angle of greater than 0° and smaller than 90° with the reflecting surface.

8. A projection system with an opto-electromechanical component for speckle reduction, the opto-electromechanical component comprising:
a micro-motor having a shaft, and
a translucent light-diffusing element mounted on the shaft, wherein the light-diffusing element is formed as an n-sided prism comprising an n-sided regular polygonal base face fixed to the shaft and n side faces, wherein n is equal to or greater than 3.

9. The projection system according to claim 8, wherein the side faces of the light-diffusing element are parallel to the shaft.

10. The projection system according to claim 8, wherein the light-diffusing element comprises n diffusing sub-elements which are fixed to each other, forming the light-diffusing element.

11. The projection system according to claim 8, wherein the light-diffusing element comprises a translucent low-angle diffractive optical element and/or a holographic optical element with low diffusion angle.

12. The projection system according to claim 8, wherein the light-diffusing element comprises a beam-shaping element.

13. The projection system according to claim 8, wherein the opto-electromechanical component further comprises a magnetic component positioned next to the micro-motor.

14. The projection system according to the claim 13, wherein the micro-motor is a piezo motor or an electric motor.

15. The projection system according to claim 8, further comprising a coherent light source emitting a coherent light beam during operation, wherein the coherent light beam is irradiated through the light-diffusing element at a right angle to the shaft of the micro-motor.
